(19) United States
(12) Patent Application Publication
(10) Pub. No.: US 2023/0086092 A1
(43) Pub. Date: Mar. 23, 2023

(54) SOLVENT REDUCABLE URETHANE COATING

(71) Applicant: Z Technologies Corporation, Redford, MI (US)

(72) Inventor: Ellis Breskman, Redford, MI (US)

(21) Appl. No.: 17/939,403

(22) Filed: Sep. 7, 2022

Related U.S. Application Data
(60) Provisional application No. 63/245,261, filed on Sep. 17, 2021.

(51) Int. Cl. C09D 175/06; B05D 3/00; B05D 1/02

(52) U.S. Cl. CPC C09D 175/06; B05D 3/002; B05D 1/02

(57) ABSTRACT

A relatively low cost, two component solvent-based urethane coating, intended to protect steel shipping containers made from modified drying oils.

### BACKGROUND OF THE INVENTION

The present invention relates generally to a solvent based two component urethane coating applied to large steel shipping containers. These large 20- and 40-foot-long steel containers are widely used to move cargo in global trade.

The prior art in the field of corrosion prevention Urethane coatings is composed of two separate components, Part A and Part B, that are mixed immediately before application. The two components chemically react to form a hard durable film. Part B consists of an isocyanate reagent and Part A contains a coating resin that can react with the isocyanate.

In the prior art, the film forming resin in Part A is composed of monomers that are relatively lightfast. For example, an autobody repair shop would utilize two component urethane enamels, where the resulting film would be non-yellowing and retain gloss for extended periods.

It is a fact that most steel shipping containers manufactured in the USA are painted low gloss pastel yellow.

The instant invention is a solvent based anti-corrosion coating offering significantly lower cost with increased protection.

### SUMMARY OF THE INVENTION

The innovation of this invention is to utilize modified drying oils in Part A of the two-component paint. Drying oils are not used in urethane enamels because they exhibit significant yellowing and gloss loss upon exterior exposure. However for pastel low gloss yellow urethane coatings this innovation results in significant cost savings, increased durability, and utilization of a renewable raw material (compared to petroleum based non yellowing resins).

### DETAILED DESCRIPTION OF THE PREFERRED EMBODIMENT

The various features and advantages of the invention will become apparent to those skilled in the art from the following detailed description of the currently preferred embodiment.

For a two-component urethane enamel, the Part B, the activator, is an aliphatic isocyanate. The composition of this component is consistently the same globally. Almost all earth paint companies use the same ingredients for the activator. For Part A, it is common practice to use an aliphatic non-yellowing and lightfast resin. A common resin is Joncryl 934, from BASF, which is widely used. This resin can produce very lightfast quick drying coatings. The current 2021 pricing for the Joncryl is $4.44 per pound. The Joncryl is made in a multistep synthesis from petroleum feedstock.

In this invention, the Part A component is made from an alkyd, a modified drying oil from processed pine trees. The preferred Part A component is made with Mancuso 3657, manufactured by Mancuso Chemicals, Ltd. Upon exterior exposure, this component will quickly yellow and lose gloss. The current pricing is $1.31 per pound. This component also exhibits better corrosion protection, adhesion and other film properties than the Joncryl 934. Part A contains approx. six pounds per gallon of resin. Because the majority of US made steel shipping containers are low gloss yellow, this component can be utilized to make a highly durable, less costly, and using a renewable resource, coating.

The foregoing description is only exemplary of the principles of the invention. Many modifications and variations of the present invention are possible in light of the above teachings. The preferred embodiments of this invention have been disclosed, however, so that one of ordinary skill in the art would recognize that certain modifications would come within the scope of this invention. It is, therefore, to be understood that within the scope of the appended claims, the invention may be practiced otherwise than as specifically described. For that reason, the following claims should be studied to determine the true scope and content of this invention.

What is claimed is:

1. A method for coating a steel shipping container by applying a mixture of a modified drying oil and an isocyanate activator to the steel shipping container.

2. The method of claim 1 wherein the ratio of modified drying oil to isocyanate activator is between two and ten parts of modified drying oil to one part isocyanate activator.

3. The method of claim 1 comprising the additional step of removing any rust from the steel shipping container prior to applying the mixture.

4. The method of claim 1 wherein the mixture is applied to the steel shipping container with a spray paint gun.

5. The method of claim 2 comprising the additional step of removing any rust from the steel shipping container prior to applying the mixture.

6. The method of claim 2 wherein the mixture is applied to the steel shipping container with a spray paint gun.

7. A method for coating a steel shipping container by applying a mixture of two to ten parts of modifying drying oil to one part of isocyanate activator to the steel shipping container.

8. The method of claim 7 comprising the additional step of removing any rust from the steel shipping container prior to applying the mixture.

9. The method of claim 7 wherein the mixture is applied to the steel shipping container with a spray paint gun.
